(19) United States
(12) Patent Application Publication
(10) Pub. No.: US 2009/0161258 A1
(43) Pub. Date: Jun. 25, 2009

(54) STORAGE DEVICE AND ASSEMBLY METHOD FOR THE SAME

(75) Inventor: Yoshihiko Nakamura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/335,204

(22) Filed: Dec. 15, 2008

(30) Foreign Application Priority Data
Dec. 21, 2007 (JP) 2007-330732

(51) Int. Cl. G11B 5/48

(52) U.S. Cl. 360/244; G9B/5.147

(57) ABSTRACT

A storage device includes a storage medium; a rotating shaft; a head actuator pivotally supported about the rotating shaft; a head fixed at an end of the head actuator for reading/writing information from/to the storage medium; and a magnetic circuit having a magnetic member and a magnet connected thereto. The magnet has a magnetic characteristic corresponding to the inertia of the head actuator. The storage device further includes a coil fixed at the other end of the head actuator. The coil generates a driving force proportional to the inertia when an electric current is flown through the coil by interaction with the magnetic circuit. The driving force causes the head actuator to be driven to adjust the head to a target position on the storage medium. The magnetic member is configured as a single unit having a common dimension among a plurality of storage devices having different specifications.

### CROSS REFERENCE TO RELATED APPLICATIONS

This application is based upon and claims the benefit of priority from the prior Japanese Patent Application No. 2007-330732 filed on Dec. 21, 2007, the entire content of which is incorporated herein by reference.

### FIELD

This art relates to a storage device structured such that a head for reading/writing information from/to a storage medium is attached to the tip end of one arm of a head actuator, which is axially supported about a rotating shaft, a coil is attached to the other arm of the head actuator, a magnetic circuit including a magnetic member including a magnet generates a magnetic force to supply a current to the coil to thereby generate a driving force of the coil, and the driving force is converted into a moving force of the head actuator to adjust the head to a target position on the storage medium.

### BACKGROUND

Storage devices typified by a magnetic disk device are provided with a head actuator for adjusting a head, which reads/writes information from/to a disk-like storage medium such as a magnetic disk, to a target position on the storage medium. The head actuator is axially supported in the form of being pivotal about a rotating shaft so as to move the head within an arc-like range defined by the radius of the storage medium. Further, in the head actuator, a VCM (voice coil motor) coil is placed on the opposite side to the head across the rotating shaft in order to give a moving force to the head actuator.

The head actuator utilizes a driving force of the VCM coil as a moving force; the driving force is generated in the magnetized VCM (voice coil motor) coil in the magnetic field generated by a main magnet in a VCM as a magnetic circuit based on the Fleming's left-hand rule.

For example, storage devices of different storage capacities are generally lined up with varying numbers of storage media, which are mounted to the storage devices. In general, the head actuator is provided for each storage medium, so a storage device having plural storage media integrated therein incorporates plural head actuator. For example, Japanese Laid-open Patent Publication No. 2001-43640 discloses a storage device capable of moving plural head actuators with a VCM.

However, conventional techniques typified by the technique disclosed in Japanese Laid-open Patent Publication No. 2001-43640 have the following problem. That is, if the storage capacity of the storage device varies, the number of head actuators varies. If the number of head actuators varies, the inertia varies in the head actuators as a whole.

Upon lining up storage devices, if actuators different in inertia are used, specific VCMs are generally prepared, which can generate a magnetic flux corresponding to a driving torque necessary for each head actuator from the viewpoint of a material of a main magnet of a VCM or a price of a yoke member. Since these VCMs are mainly different in height, corresponding base, cover, damper, and stopper is prepared. Thus, it is difficult to apply the same assembly apparatus to the storage devices. Therefore, an assembly efficiency is low, and a manufacturing cost cannot be lowered for that reason.

### SUMMARY

According to an aspect of an embodiment, a storage device includes a storage medium; a rotating shaft; a head actuator pivotally supported about the rotating shaft; a head fixed at an end of the head actuator for reading/writing information from/to the storage medium; a magnetic circuit having a magnetic member and a magnet connected thereto, the magnet having a magnetic characteristic corresponding to the inertia of the head actuator; and a coil fixed at the other end of the head actuator, for generating a driving force proportional to the inertia when an electric current is flown through the coil by interaction with the magnetic circuit, the driving force causing the head actuator to be driven to adjust the head to a target position on the storage medium, the magnetic member being configured as a single unit having a common dimension among a plurality of storage devices having different specifications.

### BRIEF DESCRIPTION OF DRAWINGS

FIG. 1 is a top view of a magnetic disk device;

FIG. 2 is a sectional view of a VCM of a magnetic disk device of the Related Art 1 (with high inertia of an actuator);

FIG. 3 is a sectional view of a VCM of a magnetic disk device of the Related Art 2 (with low inertia of an actuator);

FIG. 4 is a sectional view of a VCM of a magnetic disk device according to an embodiment (with high inertia of an actuator);

FIG. 5 is a sectional view of a VCM (I) of a magnetic disk device according to an embodiment (with low inertia of an actuator);

FIG. 6 schematically shows how an inner diameter of a magnet is changed in a magnetic disk device according to an embodiment;

FIG. 7 is a sectional view of a VCM (II) of a magnetic disk device according to an embodiment;

FIG. 8 is a sectional view of a VCM (III) of a magnetic disk device according to an embodiment (with low inertia of an actuator);

FIG. 9 is a perspective view of a VCM assembly apparatus according to an embodiment;

FIG. 10 is a block diagram illustrating the structure of a VCM assembly apparatus according to an embodiment; and

FIG. 11 is a flowchart illustrating a VCM assembly processing procedure according to an embodiment.

### DESCRIPTION OF EMBODIMENTS

Hereinafter, embodiments of a storage device, and assembly apparatus and method for the storage device will be described in detail with reference to the accompanying drawings. In the following embodiments, a storage medium is a magnetic disk, and a storage device is a magnetic disk device. However, the present invention is not limited thereto but is applicable to a wide variety of storage devices as long as the devices include a head actuator that is axially supported in the form of being pivotal about a rotating shaft, and has one end attached with a head for reading/writing information from/to a storage medium and the other end attached with a coil, and a magnetic circuit including a magnetic member attached with a magnet, the coil being capable of generating a driving force when an electric current is flown through the coil by interaction with the magnetic circuit, the driving force causing the head actuator to be driven to adjust the head to a target position on the storage medium.

### EMBODIMENTS

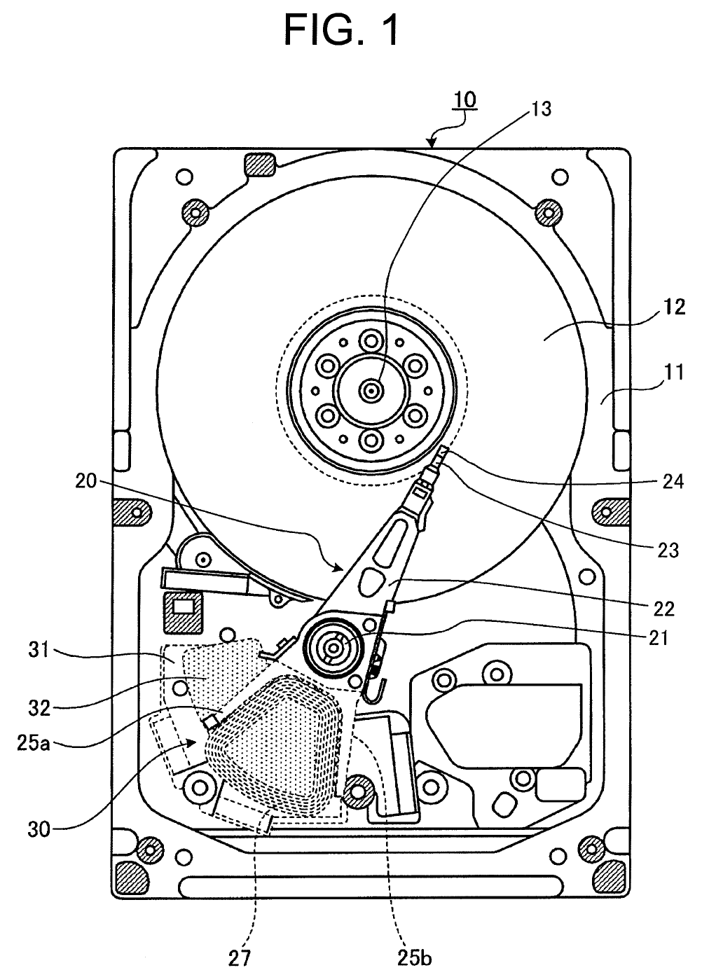

First, the schematic inner structure of a magnetic disk device is described. FIG. 1 is a top view of the magnetic disk device. In FIG. 1, an upper cover of a magnetic disk device 10 is taken off, so the inner structure of a base casing 11 of the magnetic disk device 10 can be seen, and an inner portion of a VCM coil 27 of a head actuator can be seen through an upper cover of a VCM 30, an upper yoke member, and an upper magnet.

As shown in FIG. 1, the center of a magnetic disk 12 is fixed to a rotating shaft of a spindle motor (not shown) with a disk fixture mechanism 13 in the magnetic disk device 10. The magnetic disk 12 is rotated along with the revolution of the spindle motor.

Further, in the magnetic disk device 10, a head actuator (hereinafter simply referred to as “actuator”) 20 supporting a head slider 24 provided with a magnetic head is axially supported in the form of being pivotal about a rotating shaft 21 of the actuator 20. The head slider 24 is provided on the magnetic disk 12 side of the rotating shaft 21 of the actuator 20 through a supporting arm 22 and a supporting spring 23.

The actuator 20 is provided for each magnetic disk 12. Thus, if a storage capacity of the magnetic disk device 10 is large, the number of magnetic disk 12 is accordingly increased, and plural actuators 20 are provided. For example, the inertia of the actuator 20 varies depending on the number of actuators 20.

Further, as shown in FIG. 1, in the magnetic disk device 10, the VCM coil 27 and coil arms 25a and 25b for supporting the VCM coil 27 are provided on the opposite side of the rotating shaft 21 of the actuator 20 to the magnetic disk 12. Here, the coil arms 25a and 25b are formed of aluminum from the viewpoint of processability and size reduction.

Further, in the magnetic disk device 10, the VCM 30 is structured by integrating a lower yoke member 31, a lower magnet 32 attached to an upper side of the lower yoke member 31, the upper magnet, the upper yoke member attached with the upper magnet on its lower side, a damper, and a cover to the base casing in this order. The yoke member is a kind of magnetic member. The damper is a cushioning material for suppressing vibrations of the cover.

Here, at lease one VCM coil 27 is inserted between the upper magnet and the lower magnet 32 with a predetermined distance from the upper magnet and the lower magnet 32. The VCM coil 27 is magnetized in the magnetic field generated by the upper magnet and the lower magnet 32 to thereby swing about the rotating shaft 21.

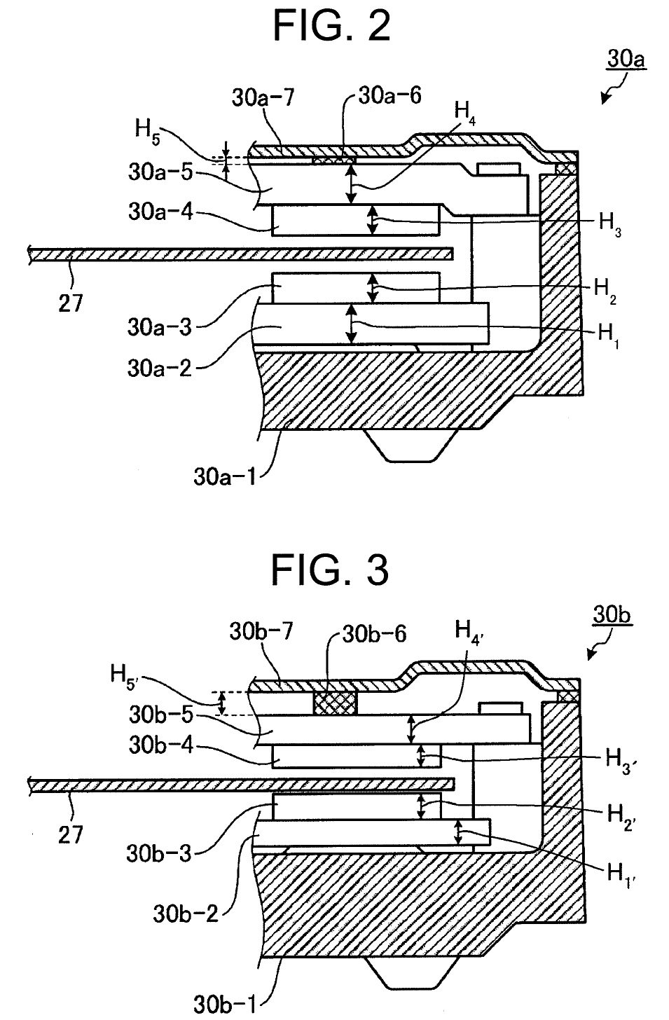

Next, a VCM of a magnetic disk device (with high inertia of the actuator) of the Related Art 1 is described. FIG. 2 is a sectional view of the VCM of the magnetic disk device of the Related Art 1 (with high inertia of the actuator). As for a VCM 30a of the magnetic disk device of the Related Art 1 (with high inertia of the actuator), a lower yoke member 30a-2 of a height H₁ attached with a lower magnet 30a-3 of a height H₂ on its upper side, and an upper yoke member 30a-5 of a height H₄ attached with a lower magnet 30a-4 of a height H₃ on its lower side, into a base casing 30a-1 in this order, such that the lower magnet 30a-3 and the upper magnet 30a-4 are integrated at a predetermined distance.

At least one VCM coil 27 is inserted between the lower magnet 30a-3 and the upper magnet 30a-4 with a predetermined distance from the lower magnet 30a-3 and the upper magnet 30a-4. Further, in the VCM 30a, a damper 30a-6 of a height H₅ is placed on the upper yoke member 30a-5, and a cover 30a-7 is placed thereon to cover the upper surface.

As described above, in the case where the inertia of the actuator 20 is high, if yoke members and magnets made of the same material are used, the heights H₁, H₂, H₃, and H₄ of the lower magnet 30a-3, the lower yoke member 30a-2, the upper magnet 30a-4, and the upper yoke member 30a-5 need to be set large enough to generate a strong magnetic field between the lower magnet 30a-3 and the upper magnet 30a-4, and in turn, the height H₅ of the damper 30a-6 should be set low.

Next, a VCM of a magnetic disk device (with low inertia of the actuator) of the Related Art 2 is described. FIG. 3 is a sectional view of the VCM of the magnetic disk device of the Related Art 2 (with low inertia of the actuator). As for a VCM 30b of the magnetic disk device of the Related Art 2 (with low inertia of the actuator), similar to the magnetic disk device of the Related Art 1 (with high inertia of the actuator), a lower yoke member 30b-2 of a height H₁ attached with a lower magnet 30b-3 of a height H₂ on its upper side, and an upper yoke member 30b-5 of a height H₄ attached with a lower magnet 30b-4 of a height H₃ on its lower side, into a base casing 30b-1 in this order, such that the lower magnet 30b-3 and the upper magnet 30a-4 are integrated at a predetermined distance.

At least one VCM coil 27 is inserted between the lower magnet 30b-3 and the upper magnet 30b-4 with a predetermined distance from the lower magnet 30b-3 and the upper magnet 30b-4. Further, in the VCM 30b, a damper 30b-6 of a height H₅ is placed on the upper yoke member 30b-5, and a cover 30b-7 is placed thereon to cover the upper surface.

As described above, in the case where the inertia of the actuator 20 is low, if yoke members and magnets made of the same material are used, the heights H₁, H_{2′}, H_{3′}, and H_{4′} of the lower magnet 30b-3, the lower yoke member 30b-2, the upper magnet 30b-4, and the upper yoke member 30b-5 need to be set small enough to generate a magnetic field of an appropriate intensity between the lower magnet 30b-3 and the upper magnet 30b-4, and in turn, the height H₅ of the damper 30b-6 should be set low.

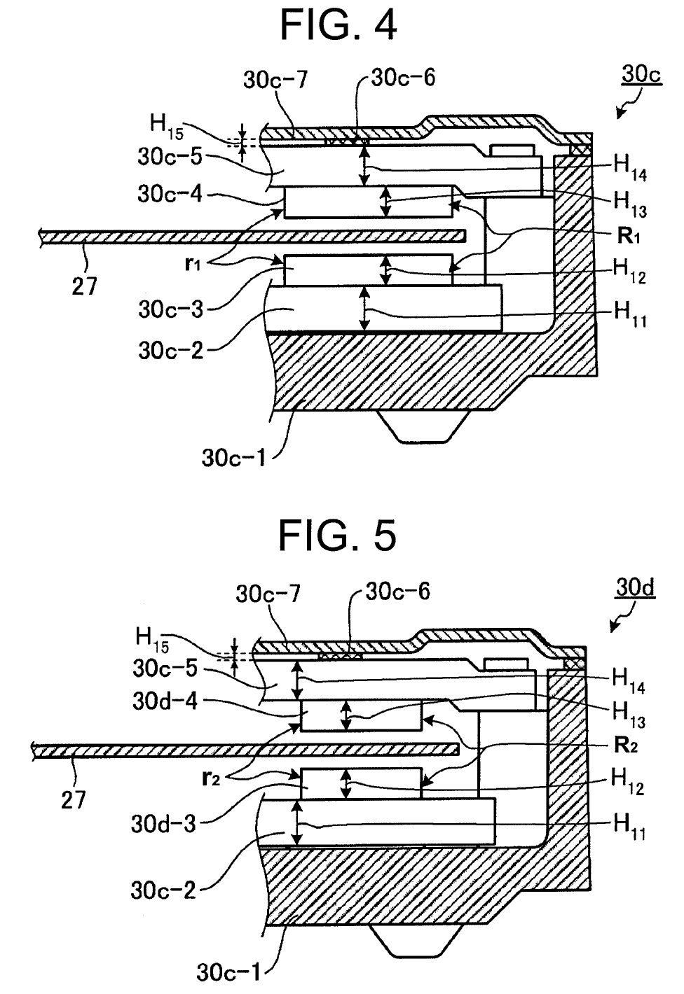

Next, a description is given of a VCM of a magnetic disk device (with high inertia of the actuator) according to an embodiment. FIG. 4 is a sectional view of the VCM of the magnetic disk device according to the embodiment (with high inertia of the actuator). As for a VCM 30c of the magnetic disk device of this embodiment (with high inertia of the actuator), similar to the magnetic disk devices of the Related Art 1 and the Related Art 2, a lower yoke member 30c-2 of a height H₁₁ attached with a lower magnet 30c-3 of a height H₁₂ with an inner diameter r₁ and an outer diameter R₁ on its upper side, and an upper yoke member 30c-5 of a height H₁₄ attached with a lower magnet 30c-4 of a height H₁₃ with an inner diameter r₁ and an outer diameter R₁ on its lower side, into a base casing 30c-1 in this order, such that the lower magnet 30c-3 and the upper magnet 30c-4 are integrated at a predetermined distance.

At least one VCM coil 27 is inserted between the lower magnet 30c-3 and the upper magnet 30c-4 with a predetermined distance from the lower magnet 30c-3 and the upper magnet 30c-4. Further, in the VCM 30c, a damper 30c-6 of a height H₁₅ is placed on the upper yoke member 30c-5, and a cover 30c-7 is placed thereon to cover the upper surface.

Here, as long as the yoke members and magnets made of the same material are used, a magnetic field that applies an appropriate moving force to the actuators 20 different in inertia can be generated only by changing the height H₁₂ of the lower magnet 30c-3 and/or the height H₁₃ of the upper magnet 30c-4 regardless of the inertia of each actuator 20.

Alternatively, as long as the yoke members and magnets made of the same material are used, a magnetic field that applies an appropriate moving force to the actuators 20 different in inertia can be generated only by changing the inner diameter r₁ of the lower magnet 30c-3 and the upper magnet 30c-4 and the outer diameter R₁ of the lower magnet 30c-3 and the upper magnet 30c-4 regardless of the inertia of each actuator 20.

Further, it is possible to generate a magnetic field that applies an appropriate moving force to the actuators 20 different in inertia by changing the height H₁₂ of the lower magnet 30c-3 and/or the height H₁₃ of the upper magnet 30c-4 and changing the inner diameter r₁ of the lower magnet 30c-3 and the upper magnet 30c-4 and the outer diameter R₁ of the lower magnet 30c-3 and the upper magnet 30c-4 in combination as appropriate.

Here, the heights H₁₁, H₁₄, and H₁₅ of the lower yoke member 30c-2, the upper yoke member 30c-5, and the damper 30c-6 are fixed, and shapes thereof are also the same. Further, sizes and shapes of the base casing 30c-1, the damper 30c-6, and the cover 30c-7 are the same as well.

This could be apparent from a sectional view of a VCM (I) of a magnetic disk device of this embodiment (with low inertia of an actuator). As for a VCM 30d of the magnetic disk device of this embodiment (with low inertia of the actuator), a lower yoke member 30d-2 of a height H₁₁ attached with a lower magnet 30d-3 of a height H₁₂ with an inner diameter r₁ and an outer diameter R₁ on its upper side, and an upper yoke member 30d-5 of a height H₁₄ attached with a lower magnet 30d-4 of a height H₁₃ with an inner diameter r₂ and an outer diameter R₂ on its lower side, into a base casing 30d-1 in this order, such that the lower magnet 30d-3 and the upper magnet 30d-4 are integrated at a predetermined distance.

Further, in the VCM 30d, a damper 30d-6 of a height H₁₅ is placed on the upper yoke member 30d-5, and a cover 30d-7 is placed thereon to cover the upper surface.

In this way, with regard to the VCM 30c and VCM 30d of this embodiment, as long as the yoke members and magnets made of the same material are used, the heights H₁₁, H₁₄, and H₁₅ of the lower yoke member 30c-2, the upper yoke member 30c-5, and the damper 30c-6 are fixed, and sizes and shapes of the base casing 30c-1, the damper 30c-6, and the cover 30c-7 are the same regardless of the inertia of each actuator 20.

In other words, as long as the yoke members and magnets made of the same material are used, regardless of the inertia of each actuator 20, the base casing 30c-1, lower yoke member 30c-2, the upper yoke member 30c-5, the damper 30c-6, and the cover 30c-7 under the same standard are used, and only the inner diameter r₂ of the lower magnet and the upper magnet and/or the outer diameter R₂ of the lower magnet and the upper magnet are changed to adjust a magnetic flux amount of a magnetic field generated between the lower magnet and the upper magnet to an appropriate value that balances with the inertia of the actuator 20.

The lower magnet and the upper magnet are provided as a component previously attached to the lower yoke member 30c-2 and the upper yoke member 30c-5. The VCM is assembled by a component handling mechanism, such as a robot hand, firmly holding a VCM component in an assembly apparatus for a magnetic disk device. Thus, even if sizes and/or shapes of the lower magnet and the upper magnet are different, as long as the lower yoke member and the upper yoke member under the same standard are used, the component handling mechanism in the assembly apparatus for a magnetic disk device can firmly catch and assemble components (under the same standard) of even the magnetic disk device 10 having the actuators 20 different in inertia. As a result, the magnetic disk device can be manufactured with high efficiency at low costs.

On the other hand, since the component handling mechanism catches a component in accordance with a parameter appropriate to size and shape of the target component, if the size or shape of the component varies, the parameter should be changed. Moreover, if the mechanism cannot catch a component different in size or shape from the preset one by changing the parameter, an assembly apparatus for a magnetic disk device including another component handling mechanism that can deal with change in component size or shape should be additionally installed, resulting in reduction in magnetic disk device manufacturing efficiency and increase in magnetic disk device manufacturing cost.

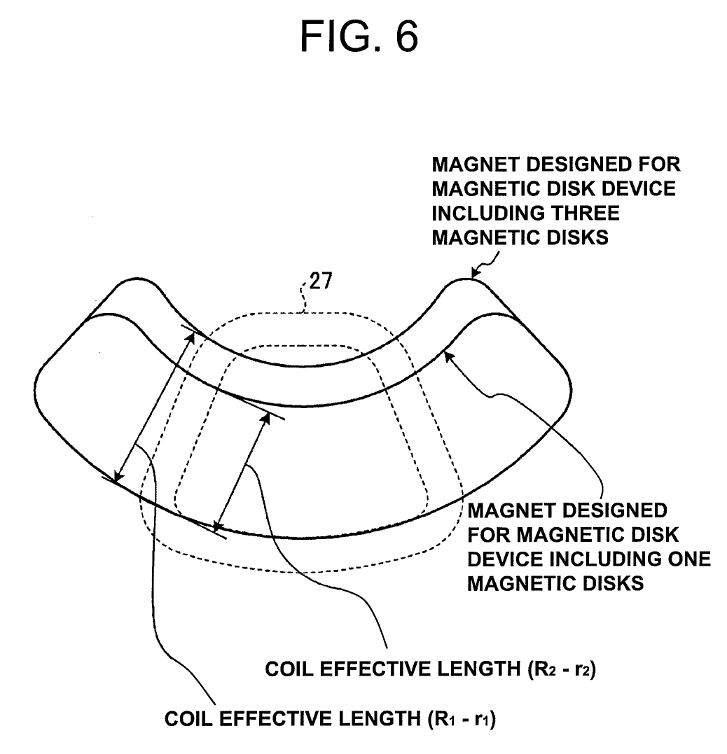

An example thereof is given below. FIG. 6 schematically shows how an inner diameter of a magnet is changed in a magnetic disk device of this embodiment. FIG. 6 is a perspective view of a positional relationship between the VCM coil 27 of the actuator 20 and the magnet of the VCM 30 as viewed from above the apparatus. For example, if the VCM 30c of FIG. 4 is designed for the magnetic disk device 10 including three magnetic disks 12, the entire straight portion of the VCM coil 27 is set as a coil effective length (outer diameter R₁-inner diameter r₁). In contrast, if the VCM 30d of FIG. 5 is designed for the magnetic disk device 10 including one magnetic disk 12, the inner diameter of the magnet is changed such that about 70% to 80% of the straight portion of the VCM coil 27 is used as a coil effective length (outer diameter R₂-inner diameter r₂), making it possible to adjust a magnetic flux amount of a magnetic field generated in the VCM.

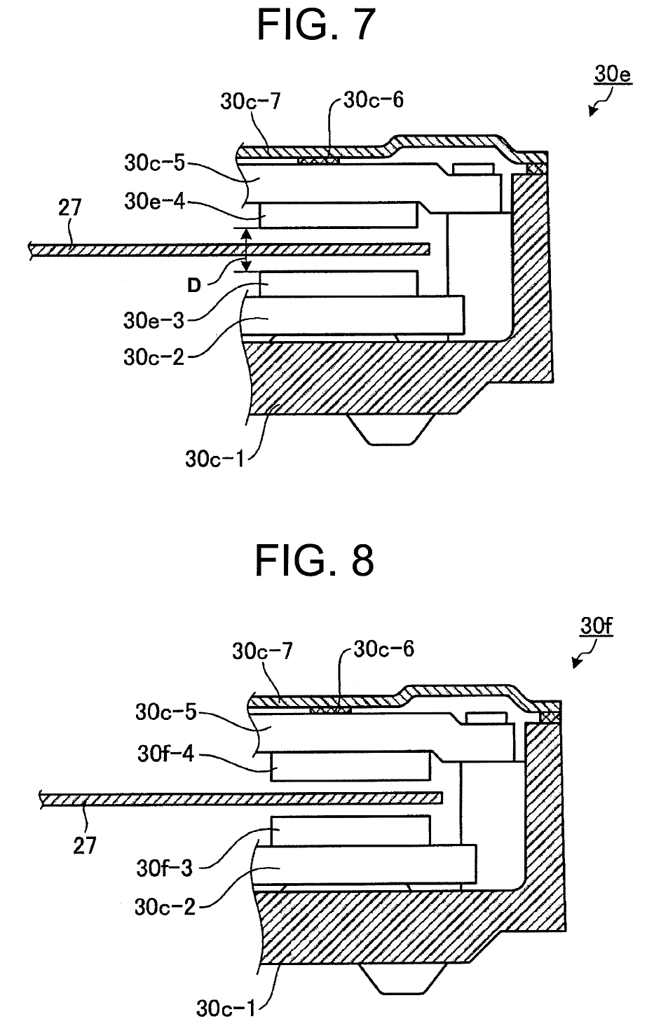

Next, a VCM (II) of a magnetic disk device of this embodiment is described. FIG. 7 is a sectional view of the VCM (II) of a magnetic disk device of this embodiment. A VCM 30e of a magnetic disk device of this embodiment changes a distance D between a lower magnet 30e-3 and an upper magnet 30e-4 (that is, heights of the lower magnet 30e-3 and the upper magnet 30e-4) to adjust a permeance coefficient (a ratio between the height H of the magnet and the distance D between the lower magnet and the upper magnet; H/D) to thereby adjust a magnetic flux amount of a magnetic field generated in the VCM 30e.

Here, also in the VCM 30e, the base casing 30c-1, lower yoke member 30c-2, the upper yoke member 30c-5, the damper 30c-6, and the cover 30c-7 under the same standard are used regardless of the inertia of each actuator 20.

Next, a VCM (III) of a magnetic disk device of this embodiment is described. FIG. 8 is a sectional view of the VCM (II) of a magnetic disk device of this embodiment (with low inertia of an actuator). A VCM 30f of a magnetic disk device of this embodiment changes a material of a lower magnet 30f-3 and an upper magnet 30f-4 (that is, replaces the lower magnet 30f-3 and the upper magnet 30f-4 by magnets of a material different in the energy product from the material for the lower magnet 30f-3 and the upper magnet 30f-4) to thereby adjust a magnetic flux amount of a magnetic field generated in the VCM 30f.

Here, also in the VCM 30f, the base casing 30c-1, lower yoke member 30c-2, the upper yoke member 30c-5, the damper 30c-6, and the cover 30c-7 under the same standard are used regardless of the inertia of each actuator 20.

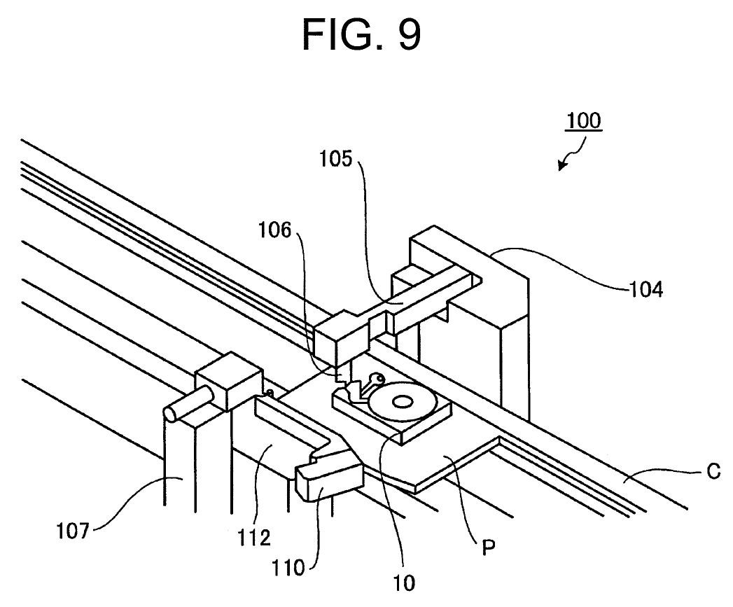

Next, a VCM assembly apparatus of this embodiment is described. FIG. 9 is a perspective view of the VCM assembly apparatus of this embodiment. Although the magnetic disk device 10 is actually sealed with a cover (not shown), in FIG. 9, the cover is taken from the magnetic disk device 10 for integrating and assembling the VCM.

A VCM assembly apparatus 100 is mainly composed of a pallet P on which the magnetic disk device 10 is placed to assemble the VCM 30, a pallet conveyor C for conveying the pallet P, an arm mechanism 104 for driving a pivot arm 105 having a robot hand (component handling mechanism) 106 at the tip end, an arm mechanism 107 for driving an extra holding arm 110, and a pallet conveyor mechanism 112 for driving the pallet conveyor C.

The robot hand 106 firmly holds and installs the base casing 30c-1, the lower yoke member 30c-2, the upper yoke member 30c-5, the damper 30c-6, and the cover 30c-7 as assembly components of the VCM 30 prepared near the VCM assembly apparatus 100, into the magnetic disk device 10 transferred on the pallet P on the pallet conveyor C in order.

Further, the extra holding arm 110 holds the magnetic disk device 10 on the pallet P for smooth assembly of the assembly components during the assembly of the assembly components with the robot hand 106.

In the illustrated example of FIG. 9, the magnetic disk 12 is already incorporated in the magnetic disk device 10 placed on the pallet P but the VCM 30 and the actuator 20 are not yet incorporated.

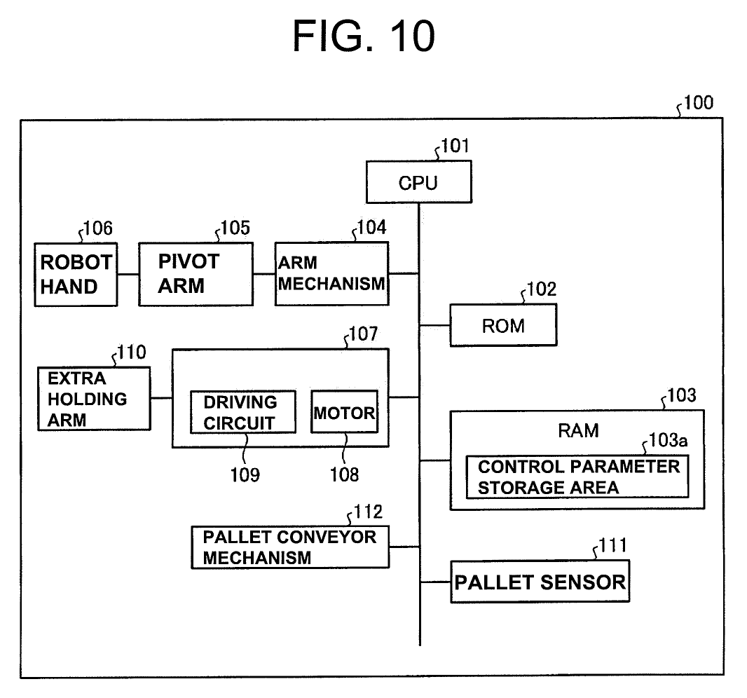

Next, the structure of the VCM assembly apparatus of this embodiment is described. FIG. 10 is a block diagram illustrating the structure of the VCM assembly apparatus of this embodiment. The VCM assembly apparatus 100 includes a CPU (central processing unit) 101 that reads a control program from a ROM 102 and executes the read program to control VCM assembly processing with the VCM assembly apparatus 100, a RAM 103 including parameter storage area 103a for storing a parameter of the VCM assembly apparatus 100, the arm mechanism 104 for driving the pivot arm 105 having the robot hand 106 at the tip end, the arm mechanism 107 including a motor 108 and a driving circuit 109 for driving the extra holding arm 110, a pallet sensor 111 for detecting that the pallet P reaches an operation position of the robot hand 106, and the pallet conveyor mechanism 112 for driving the pallet conveyor C.

The VCM assembly apparatus 100 integrates the base casing 30c-1, the lower yoke member 30c-2, the upper yoke member 30c-5, the damper 30c-6, and the cover 30c-7 into the magnetic disk device 10, regardless of the inertia of the actuator 20. The robot hand 106 can firmly catch components in accordance with fixed parameters because lower yoke member 30c-2 and the upper yoke member 30c-5 each have a common dimension among a plurality of storage devices having different specifications. The fixed parameters include location information of the lower yoke member 30c-2 and the upper yoke member 30c-5 before the robot hand 106 holds the lower yoke member 30c-2 and the upper yoke member 30c-5, position information where the robot hand 106 holds the lower yoke member 30c-2 and the upper yoke member 30c-5, and position information where the lower yoke member 30c-2 and the upper yoke member 30c-5 are disposed in the magnetic disk device 10, etc. Likewise, a fixed control program can be used as a control program stored in the ROM 102.

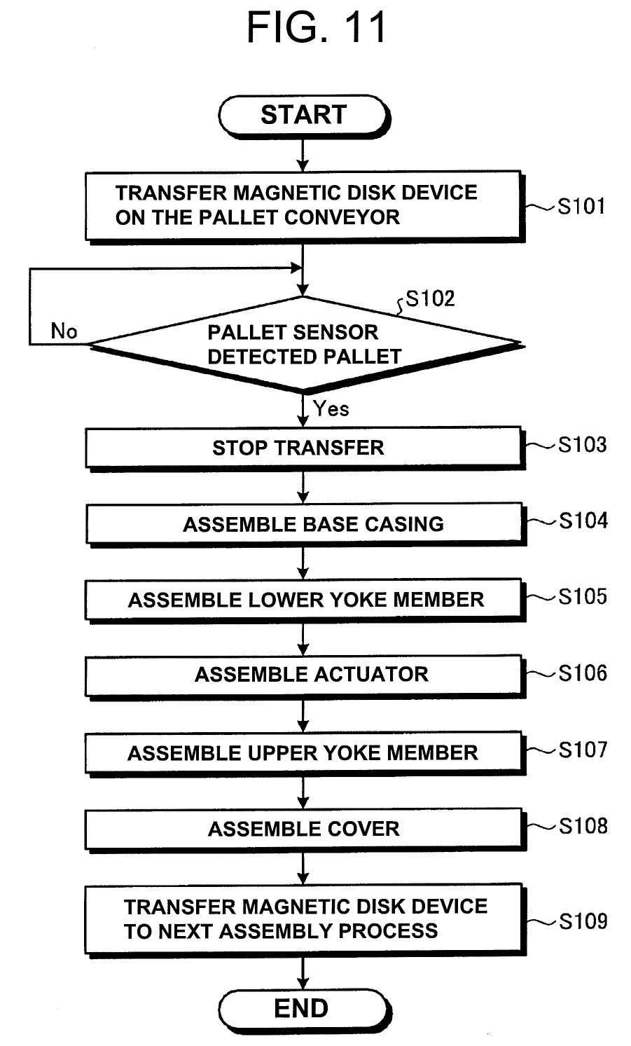

Next, a description is made of VCM assembly processing executed by the VCM assembly apparatus 100 of this embodiment. FIG. 11 is a flowchart illustrating a VCM assembly processing procedure of this embodiment. As shown in FIG. 11, the pallet conveyor CPU 101 first controls the pallet conveyor mechanism 112 to transfer the magnetic disk device 10 not integrated with a VCM, on the pallet conveyor C (step S101).

Next, the pallet conveyor CPU 101 determines whether the pallet sensor 111 detected the pallet P (step S102). If the pallet conveyor CPU determines that the pallet sensor 111 detected the pallet P (YES in step S102), the processing advances to step S103, and otherwise (NO in step S102), the process in step S102 is repeated.

In step S103, the pallet conveyor CPU 101 controls the pallet conveyor mechanism 112 to stop the transfer of the magnetic disk device 10 on the pallet P at the operation position of the robot hand 106. Next, the pallet conveyor CPU 101 controls the arm mechanism 104 to rotate the pivot arm 105 to assemble the base casing, the lower yoke member, the actuator, the upper yoke member, and the cover in order into the magnetic disk device 10 with the robot hand 106 (steps S104, S105, S106, S107, and S108).

After the completion of the processing in step S108, the pallet conveyor CPU 101 controls the arm mechanism 104 to transfer the magnetic disk device 10 on the pallet P to the next assembly process (step S109).

In the above VCM assembly processing procedure, the transfer of the magnetic disk device 10 on the pallet P is stopped once to assemble the base casing, the lower yoke member, the actuator, the upper yoke member, and the cover in order into the magnetic disk device 10. However, the present invention is not limited thereto. Different assembly apparatuses may be used for components of the VCM and arranged along the pallet conveyor C following the component assembly order and then, one component may be assembled upon each operation of stopping the transfer of the pallet P.

Here, if a magnetic circuit designed for an actuator having high inertia (for example, three magnetic disks) is used, an actuator having low inertia (for example, one magnetic disk) can be driven. However, the magnetic circuit designed for an actuator having high inertia involves a large volume of magnet or yoke member and a high material cost, leading to an increase in price of the magnetic circuit.

However, according to the above embodiment, it is possible to operate actuators of every conceivable inertia only by changing the magnet the cost of which is high compared to the other material cost. Thus, components such as the base casing, the lower yoke member, the upper yoke member, the cover, the damper, and the stopper can be shared as well as a cost of the magnetic circuit can be saved. The total cost can be saved due to the reduction in magnetic disk device manufacturing cost and the sharing of the magnetic disk device assembly apparatus.

The embodiments are described above. However, the present invention is not limited to the embodiment but may be embodied in various modifications within the scope of the technical idea described in the scope of claims. Further, the advantages of the present invention are not limited to the advantages described in the embodiment.

In the magnetic disk device assembly processing described in the above embodiment, all or a part of the automatic processing may be manually performed. Alternatively, all or a part of the manual processing may be performed based on any known method or automatically. Further, the processing procedure, the control procedure, the name, and information including various kinds of data or parameters may be arbitrarily changed unless otherwise specified.

Further, the components of the magnetic disk device assembly apparatus are illustrated for explaining a functional concept thereof and thus, its physical structure may be different from the illustrated structure. In other words, the specific disassembly and integration form of the magnetic disk device assembly apparatus is not limited to the illustrated one, and all or a part of the components may be functionally or physically disassembled or integrated in arbitrary units in accordance with various levels of load or use conditions.

Further, all or some of processing functions performed in the magnetic disk device assembly apparatus may be realized using a program analyzed and executed on a CPU (central processing unit) (or a microcomputer such as an MPU (microprocessing unit) of MCU (microcontroller unit) or realized as wired-logic-based hardware.

The present invention is effective in achieving the sharing of a storage device assembly unit even in the case of using actuators different in inertia of a head, in a storage device, and assembly apparatus and method for the storage device.

The above embodiments produce the following beneficial effect. That is, even if the inertia of the head actuator varies between the storage devices, the casing component and the magnetic member of the magnetic circuit are configured based on the single design, and only the characteristic of the magnet varies, whereby components can be shared, a manufacturing process can be performed with higher efficiency, and a manufacturing cost can be saved.

In addition, the above embodiments produce the following beneficial effect. That is, in the case of assembling storage devices different in inertia of a head actuator, an assembly apparatus for a storage device can be controlled based on a single parameter without stopping the assembly apparatus for a storage device and resetting a parameter of the assembly apparatus, a manufacturing process can be performed with higher efficiency, and a manufacturing cost can be saved.

What is claimed is:

1. A storage device comprising:
a storage medium;
a rotating shaft;
a head actuator pivotally supported about the rotating shaft;
a head fixed at an end of the head actuator for reading/writing information from/to the storage medium;
a magnetic circuit having a magnetic member and a magnet connected thereto, the magnet having a magnetic characteristic corresponding to the inertia of the head actuator; and
a coil fixed at the other end of the head actuator, for generating a driving force proportional to the inertia when an electric current is flown through the coil by interaction with the magnetic circuit, the driving force causing the head actuator to be driven to adjust the head to a target position on the storage medium, the magnetic member being configured as a single unit having a common dimension among a plurality of storage devices having different specifications.

2. The storage device according to claim 1, wherein the magnetic characteristic is an inner diameter and/or an outer diameter of the magnet having an arc shape.

3. The storage device according to claim 1, wherein the magnetic characteristic is a height of the magnet provided above and below the coil of the head actuator.

4. The storage device according to claim 1, wherein the magnetic characteristic is a material of the magnet.

5. An assembly apparatus for a storage device including a rotating shaft; a head actuator pivotally supported about the rotating shaft; a head fixed at an end of the head actuator for reading/writing information from/to a storage medium; a magnetic circuit having a magnetic member and a magnet coupled thereto; and a coil fixed at the other end of the head actuator, for generating a driving force proportional to the inertia when an electric current is flown through the coil by interaction with the magnetic circuit, the driving force causing the head actuator to be driven to adjust the head to a target position on the storage medium, the assembly apparatus comprising:
a handling unit for holding and installing the magnetic member with the magnet into one of a plurality of storage devices having different inertias of the head actuator so as to assemble the magnetic circuit, the magnetic member having a single common configuration among the different storage devices so as to facilitate holding and installing;
a storage unit for storing a parameter corresponding to the magnetic member, the parameter being adapted to control the operation of holding the magnetic member by the handling unit; and
a control unit for controlling the handling unit according to the parameter stored in the storage unit.

6. An assembly method for a storage device including a rotating shaft; a head actuator pivotally supported about the rotating shaft; a head fixed at an end of the head actuator for reading/writing information from/to a storage medium; a magnetic circuit having a magnetic member and a magnet coupled thereto; and a coil fixed at the other end of the head actuator, for generating a driving force proportional to the inertia when an electric current is flown through the coil by interaction with the magnetic circuit, the driving force causing the head actuator to be driven to adjust the head to a target position on the storage medium, the method comprising:
holding the magnetic member with the magnet; and
installing the magnetic member with the magnet into a plurality of storage devices having different inertias of the head actuator so as to assemble the magnetic circuit, the magnetic member having a single common configuration among the different storage devices so as to facilitate holding and installing.
